(19) United States
(12) Patent Application Publication
(10) Pub. No.: US 2012/0090311 A1
(43) Pub. Date: Apr. 19, 2012

(54) ACTUATING SYSTEM FOR A MOVABLE AIRCRAFT ENGINE NACELLE ELEMENT, SUCH AS A THRUST REVERSER COVER

(75) Inventors: Vincent Pierre Germain Le Coq, L A Riviere Saint Sauveur (FR); Pierre Moradell-Casellas, Saint Georges Des Groseillers (FR); Hakim Maalioune, Orgeval (FR); Alexandre Descamps, Paris (FR)

(73) Assignee: AIRCELLE, Gonfreville L'Orcher (FR)

(21) Appl. No.: 13/375,383

(22) PCT Filed: Jun. 23, 2010
(86) PCT No.: PCT/FR2010/051284

§ 371 Date: Dec. 16, 2011

(30) Foreign Application Priority Data
Jul. 9, 2009 (FR) 09/03388

(51) Int. Cl. F15B 13/00

(52) U.S. Cl. 60/484

(57) ABSTRACT

This system for actuating at least one aircraft nacelle element comprises at least two actuators (A1, A2, A3) kinematically linked together, a main hydraulic (or electric) generation circuit (1) able to operate at least one (A1) of the two actuators, and a secondary electric (or hydraulic) generation circuit (13) able to operate the other actuator (A3).

### TECHNICAL FIELD

The present invention relates to an actuating system for a movable aircraft engine nacelle element, such as a thrust reverser cover.

### BRIEF DISCUSSION OF RELATED ART

An aircraft engine nacelle surrounds the engine and performs a certain number of functions, including the thrust reverser function.

As is known in itself, this thrust reverser function makes it possible, during landing, to orient part of the thrust from the engine toward the front of the aircraft, and thereby reduce the braking distance.

In a grid thrust reverser system, this modification of the orientation of part of the thrust is done by causing one or more elements forming a thrust reverser cover to slide, thereby making it possible to expose grids that deflect the secondary air flow (cold flow) from the engine toward the front of the nacelle.

Traditionally, these elements forming the reverser cover are actuated using a plurality of mechanical (typically of the ball screw type) or hydraulic (piston-type) actuators distributed on the periphery of the nacelle, controlled by a hydraulic generation circuit of the aircraft, or by an electrical generation circuit connected to the general electrical circuit of the aircraft.

Hydraulic generation means, in the context of the present description, that the energy source is hydraulic, the control of the actuators being able to be hydraulic (hydraulic actuator) or mechanical (hydraulic motor acting on mechanical actuator).

Likewise, in the context of the present invention, electrical generation means that the energy source is electric, the control of the actuators being able to be mechanical (electric motor acting on a mechanical actuator) or hydraulic (electric motor acting on a hydraulic motor via a hydraulic pump).

As is known in itself, these actuators are kinematically connected to one another, typically by flexible shafts (commonly called “flexshafts”) in the case of mechanical actuators, so that controlling one of them also controls the other.

### BRIEF SUMMARY

The present invention aims in particular to provide means making it possible to offset a failure of the hydraulic or electrical generation circuit of the actuators, so that the function performed by the actuated element is not affected.

This aim of the invention is achieved with a system for actuating at least one aircraft nacelle element, comprising at least two actuators kinematically connected to one another, a primary hydraulic (electric, respectively) generation circuit able to control at least one of the two actuators, and a secondary electric (hydraulic, respectively) generation circuit able to control the other actuator.

Owing to these features, in case of breakdown of the primary circuit powered by one type of energy, the secondary circuit powered by another type of energy takes over, and the kinematic connection between the actuators makes this switching from one circuit to the other indifferent relative to the movement of the nacelle element.

According to other optional features of the actuating system according to the invention:
said actuators are mechanical, said primary circuit uses hydraulic generation acting on a hydraulic motor acting on one of the actuators and said secondary circuit uses electric generation comprising an electric motor acting on a hydraulic pump in turn acting on a hydraulic motor acting on another actuator,
said actuators are mechanical, said primary circuit uses hydraulic generation acting on a hydraulic motor acting on one of the actuators, and said secondary circuit uses electric generation comprising an electric motor acting directly on another actuator,
said actuators are mechanical, said primary circuit uses electric generation comprising an electric motor acting directly on an actuator and said secondary circuit uses hydraulic generation acting on a hydraulic motor acting on another actuator,
said actuators are hydraulic, said primary circuit uses hydraulic generation acting directly on one of the actuators and said secondary circuit uses electric generation comprising an electric motor acting on a hydraulic pump acting directly on another actuator,
said actuators are hydraulic, said primary circuit uses electric generation acting on a hydraulic pump in turn acting on one of the actuators and said secondary circuit uses hydraulic generation acting directly on another actuator,
said system comprises three actuators kinematically connected to one another, said primary circuit with hydraulic (electric, respectively) generation and said second electric (hydraulic, respectively) generation circuit respectively being connected to the two end actuators of the kinematic chain formed by the three actuators: owing to these features, in case of break of the kinematic transmission means (e.g. flexshafts in the case of mechanical actuators) between two actuators, one can continue to make the three actuators operate by using the primary and secondary circuits at once.

### BRIEF DESCRIPTION OF THE DRAWINGS

Other features and advantages of the invention will appear in light of the following description, and upon examining the appended figures, in which:

FIG. 1 diagrammatically illustrates the control circuit of a first embodiment of the system according to the invention, and

FIG. 2 diagrammatically illustrates a second embodiment of this system.

In these two figures, the symbols currently used in the field of hydraulic circuits are used.

In both of these figures, identical or similar references designate identical or similar sets of members.

### DETAILED DESCRIPTION

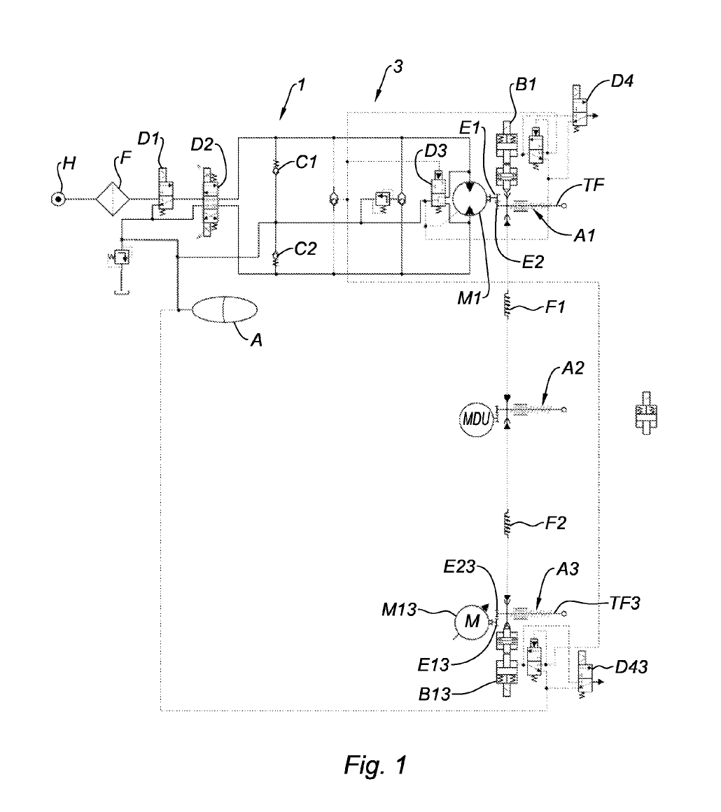

FIG. 1 shows three mechanical actuators A1, A2, A3, of the ball screw type, known in themselves: such actuators make it possible to obtain the translation of a threaded rod, from the rotation of that rod inside a fixed threading.

The three actuators A1, A2, A3 are in particular intended to slide the cover of a grid thrust reverser (not shown), equipping an aircraft nacelle.

In this case, the three actuators A1, A2, A3 are spaced angularly apart regularly on the periphery of the nacelle, so as to allow a balanced distribution of the actuating forces of the reverser cover.

These three actuators A1, A2, A3 are connected to one another by flexible transmission shafts, commonly called “flexshafts,” allowing mutual driving of the rotary threaded rods of said actuators.

More specifically, as shown in FIG. 1, a first flexshaft F1 connects the first actuator A1 to the second actuator A2, and a second flexshaft F2 connects the second actuator A2 to the third actuator A3.

FIG. 1 shows a hydraulic circuit 1 for controlling the first actuator A1.

This hydraulic circuit 1, shown in solid lines, is said to use hydraulic generation, in that it draws its hydraulic pressure source H from the primary hydraulic circuit of the aircraft.

This hydraulic circuit 1 is traditional, and for that reason will be described very briefly.

As shown in FIG. 1, this hydraulic circuit 1 comprises a filter F, three distributors D1, D2, D3, two pre-loaded check valves C1, C2, an accumulator A, all of these elements being hydraulically connected to one another so as to allow the selective actuation, and in one direction or another, of a constant displacement hydraulic motor with two directions of rotation M1.

This motor M1 includes, at its output, a gear E1 cooperating with the gear E2 of the rotary threaded rod TF of the first actuator A1.

The hydraulic control circuit 1 is also connected to an electronic braking circuit 3, shown in broken lines, making it possible to act selectively on a brake D1, making it possible to brake the rotation of the threaded rod TF of the actuator A1.

This braking circuit 3 also includes a distributor 4 making it possible to act selectively on a locking pin of the actuator A1 (primary locking system), making it possible to secure the closed position of the thrust reverser cover.

It will be noted that the braking circuit 3 also makes it possible to act on the third actuator A3, via elements similar to those of the actuator A1, these elements being designated by references similar to those concerning the first actuator A1, but ending with the number 3: B13, D43, E13, E23.

Remarkably, according to the invention, one can see that the input pinion E23 of the threaded rod TF3 is driven by a pinion E13 mounted on the output shaft of a brushless electric motor M13.

One can therefore say that the control of the third actuator A3 uses electric generation in that the energy source allowing the operation of that actuator is electric.

The operating mode and the advantages of the embodiment described above are as follows.

In the normal operating mode, to operate the three actuators A1, A2, A3, one uses both the hydraulic circuit 1 and the electric motor M13, making it possible to act respectively on the first actuator A1 and on the third actuator A3, the operation of the second central actuator A2 being ensured by the flexshafts F1, F2.

As is known in itself, before any opening operation of the thrust reverser cover, one starts by unlocking the primary bolts D4 and D43 using the circuit 3, and during the movement of the thrust reverser cover, one acts through well-determined strategies using the braking circuit 3 on the brakes D1 and D13, so as to precisely control the movement of the thrust reverser cover.

In case of problem on the primary hydraulic pressure source of the aircraft, the operation of the hydraulic circuit 1 can prove defective.

In this case, the operation of the electric motor M13 makes it possible to offset that drawback, in that the motor, whereof the energy source is electric and therefore clearly distinct from the hydraulic energy source of the aircraft, can drive not only the third actuator A3, but also the first and second actuators A1 and A2 via flexshafts F1 and F2.

One therefore understands that the system according to the invention makes it possible to keep a normal operating mode of the actuators despite a significant breakdown on the primary hydraulic circuit of the aircraft: this system is therefore very safe.

Furthermore, due to the driving of the end actuators A1, A3 each by a unique motor, it is possible to deal with the breaking of a flexshaft F1 or F2.

In such a case, the remaining flexshaft continues to drive the central actuator A2, and one therefore obtains a continuous operation of the three actuators in that way.

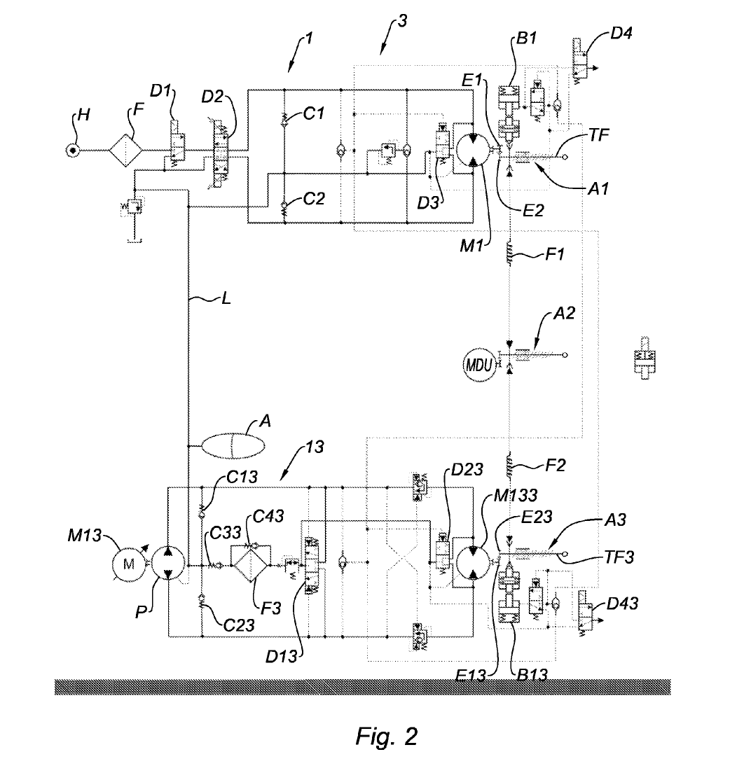

FIG. 2 shows another embodiment of the system according to the invention.

As shown in FIG. 2, the hydraulic control 1 and braking 3 circuits of the first actuator A1 are identical to those of the first embodiment, and therefore will not be described again.

The difference lies in the control means of the third actuator A3.

Unlike the previous embodiment, in which the control of said third actuator A3 was done directly by an electric motor, in the case at hand, this control is ensured by a hydraulic motor M133 similar to the hydraulic motor M1 (i.e. with constant displacement and two directions of rotation), said hydraulic motor M133 being powered by a hydraulic circuit 13 comprising a constant displacement pump P driven by a brushless electric motor M13 similar to that of the previous embodiment.

The hydraulic circuit 13 essentially comprises a hydrostatic loop, widely used in other industrial applications, such as lifting: this hydraulic circuit 13 includes in particular a plurality of preloaded check valves C13, C23, C33, C43, a filter F3, and two distributors D13, D23.

As one can therefore understand, in this second embodiment, the operation of the third mechanical actuator A3 is ensured by a hydraulic circuit 13 whereof the pressure source uses electric generation: this pressure is obtained using an electric motor M13 totally independent of the pressure source H of the primary hydraulic circuit of the aircraft.

Thus, as in the previous case, in the event of a breakdown of the primary hydraulic circuit of the aircraft, the backup hydraulic circuit 13 can continue to operate autonomously, using the electric energy source powering the motor M13.

As in the previous case, in a normal operating mode, both the primary hydraulic circuit 1 and the backup hydraulic circuit 13 are operating, so that there is redundancy.

It is possible to consider a hydraulic connection L between these two circuits, so that in case of breakdown of the primary hydraulic circuit of the aircraft, the pump P can power not only the backup circuit 13, but also the primary circuit 1.

As will already have been understood in light of the preceding description, the invention provides, owing to independent energy sources, a system making it possible to offset a breakdown on the primary hydraulic circuit of the aircraft.

Of course, the present invention is in no way limited to the embodiments described and shown.

It is thus also possible to consider applying the invention to systems in which:
the actuators are mechanical, the primary circuit uses electrical generation comprising an electric motor acting directly on an actuator and the secondary circuit uses hydraulic generation acting on a hydraulic motor acting on another actuator,
the actuators are hydraulic, the primary circuit uses hydraulic generation acting directly on one of the actuators and the secondary circuit uses electric generation comprising an electric motor acting on a hydraulic pump acting directly on another actuator,
the actuators are hydraulic, the primary circuit uses electric generation acting on a hydraulic pump in turn acting on one of the actuators and the secondary circuit uses hydraulic generation acting directly on another actuator.

The precepts of the present invention are of course applicable to the actuation of a thrust reverser cover, but more generally to the actuation of all types of mobile elements on an aircraft nacelle.

The invention is in particular applicable for the operation of dual actuators, i.e. actuators comprising a rod making it possible to actuate a first mobile element, and a second rod mounted telescoping on the first, making it possible to actuate a second mobile element at the same time.

Such a specific application is useful in particular for the combined actuation of a thrust reverser cover and the downstream portion thereof forming a variable fan nozzle (VFN): such a configuration is in particular known from prior art document GB 2 446 441.

It will lastly be noted that the present invention was described in the particular context of the use of three actuators, but can of course be generalized to two actuators, or more than three actuators.

1. A system for actuating at least one aircraft nacelle element, comprising:
at least two actuators kinematically connected to one another,
a primary hydraulic generation circuit able to control at least one of the two actuators, and
a secondary electric generation circuit able to control the other actuator.

2. The system according to claim 1, wherein said actuators are mechanical, said primary circuit uses hydraulic generation acting on a hydraulic motor acting on one of the actuators and said secondary circuit uses electric generation comprising an electric motor acting on a hydraulic pump in turn acting on a hydraulic motor (M133) acting on another actuator.

3. The system according to claim 1, wherein said actuators are mechanical, said primary circuit uses hydraulic generation acting on a hydraulic motor acting on one of the actuators, and said secondary circuit uses electric generation comprising an electric motor acting directly on another actuator.

4. The system according to claim 1, wherein said actuators are mechanical, said primary circuit uses electric generation comprising an electric motor acting directly on an actuator and said secondary circuit uses hydraulic generation acting on a hydraulic motor acting on another actuator.

5. The system according to claim 1, wherein said actuators are hydraulic, said primary circuit uses hydraulic generation acting directly on one of the actuators and said secondary circuit uses electric generation comprising an electric motor acting on a hydraulic pump acting directly on another actuator.

6. The system according to claim 1, wherein said actuators are hydraulic, said primary circuit uses electric generation acting on a hydraulic pump in turn acting on one of the actuators and said secondary circuit uses hydraulic generation acting directly on another actuator.

7. The system according to claim 1, comprising three actuators kinematically connected to one another, said primary circuit with hydraulic generation and said secondary electric generation circuit respectively being connected to two end actuators of a kinematic chain formed by the three actuators.
